(19) United States
(12) Patent Application Publication
(10) Pub. No.: US 2026/0356698 A1
(43) Pub. Date: Nov. 12, 2026

(54) WATER FILTRATION SYSTEMS FOR TWO OR MORE APPLIANCES

(71) Applicant: Haier US Appliance Solutions, Inc., Wilmington, DE (US)

(72) Inventors: AiSong Yang, Louisville, KY (US); Timothy David Kaiser, Louisville, KY (US)

(21) Appl. No.: 19/202,214

(22) Filed: May 8, 2025

(51) Int. Cl. C02F 1/00

(52) U.S. Cl. CPC C02F 1/003; C02F 2201/004; C02F 2201/005; C02F 2209/005; C02F 2209/40; C02F 2307/12

(57) ABSTRACT

Systems for water filtration for two or more appliances are provided. The system includes a stand-alone first appliance comprising: an inlet water valve connected to a first water line; a water filter connected to the first water line and a distribution valve; the distribution valve connected to a second water line and a third water line; a water dispenser valve connected to the second water line; a first control circuit configured to: generate a control signal based on a user input and a water parameter; and selectively operate the water dispenser valve and the inlet water valve based on the control signal. The system also includes a stand-alone second appliance comprising: a second water dispenser valve connected to the third water line; and the second control circuit configured to: receive the control signal from the first control circuit; and selectively operate the second water dispenser valve based on the control signal.

### FIELD

The present disclosure relates generally to water filtration systems for two or more appliances.

### BACKGROUND

In current stand-alone refrigerators and stand-alone freezers, there is a need for two separate connections to an external water supply, one for each appliance. This dual connection requires a separate water filter for each appliance. Each filter performs the same task of purifying the incoming water before directing it to its respective components. This redundancy results in unnecessary maintenance costs, as users must replace two filters at regular intervals, effectively doubling the expense of maintaining clean water for the system. Additionally, the need for multiple filters introduces inefficiencies in resource utilization, as each filter undergoes wear and degradation independently, despite serving the same fundamental purpose.

Accordingly, improved water filtration systems for two or more appliances are desired in the art. In particular, water filtration systems for two or more appliances which provide a more streamlined solution that consolidates water filtration would be advantageous.

### BRIEF DESCRIPTION

Aspects and advantages of the invention in accordance with the present disclosure will be set forth in part in the following description, or may be obvious from the description, or may be learned through the practice of the technology.

In accordance with one embodiment, a system for water filtration for two or more appliances is provided. The system includes a stand-alone first appliance comprising: an inlet water valve fluidically connected to a first water line; a water filter fluidically connected to the first water line and a distribution valve; the distribution valve fluidically connected to a second water line and a third water line; a water dispenser valve fluidically connected to the second water line; a first control circuit configured to: generate a control signal based on a user input and a water parameter; and transmit the control signal to a second control circuit; selectively operate the water dispenser valve and the inlet water valve based on the control signal. The system includes a stand-alone second appliance comprising: a second water dispenser valve fluidically connected to the third water line; and the second control circuit configured to: receive the control signal from the first control circuit; and selectively operate the second water dispenser valve based on the control signal.

In accordance with another embodiment, a system for water filtration for two or more appliances is provided. The system includes a stand-alone first appliance comprising: an inlet water valve fluidically connected to a first water line; a water filter fluidically connected to the first water line and a distribution valve; the distribution valve fluidically connected to a second water line and a third water line; a water dispenser valve fluidically connected to the second water line; a first control circuit configured to: generate a control signal based on a user input and a water parameter; transmit the control signal to a second control circuit; and selectively operate, using a double pole double throw (DPDT) relay, the water dispenser valve and the inlet water valve based on the control signal. The system also includes a stand-alone second appliance comprising: a second water dispenser valve fluidically connected to the third water line; and a second control circuit configured to: receive the control signal from the first control circuit; and selectively operate, using the DPDT relay, the second water dispenser valve based on the control signal.

In accordance with a third embodiment, a system for water filtration for two or more appliances is provided. The system includes a stand-alone first appliance comprising: an inlet water valve fluidically connected to a first water line; a water filter fluidically connected to the first water line and a distribution valve; the distribution valve fluidically connected to a second water line and a third water line; a water dispenser valve fluidically connected to the second water line; a first control circuit configured to: generate a control signal based on a user input and a water parameter; transmit the control signal to a second control circuit; and selectively operate, using a double pole double throw (DPDT) relay, the water dispenser valve and the inlet water valve based on the control signal. The system also includes a stand-alone second appliance comprising: a second water dispenser valve fluidically connected to the third water line; and a second control circuit configured to: receive the control signal from the first control circuit; and selectively operate, using the DPDT relay, the second water dispenser valve based on the control signal.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a diagram of a water filtration system for two or more appliances in accordance with embodiments of the present disclosure;

FIG. 2 is a diagram of a water filtration system for two or more appliances in accordance with embodiments of the present disclosure;

FIG. 3 is a block diagram for a water filtration system for two or more appliances in accordance with embodiments of the present disclosure;

FIG. 4 is an isometric view of two or more appliances in accordance with embodiments of the present disclosure; and

FIG. 5 is a flow diagram of an exemplary method of water filtration for two or more appliances in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first,” “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

The following disclosure discusses the fluidic connection between several components of the system. As used in the current disclosure, a fluidic connection refers to a pathway that allows the flow of a fluid, such as water or another liquid, between two or more components within a system. This connection may be established through tubing, piping, channels, or integrated conduits that facilitate the controlled movement of fluid from one point to another.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

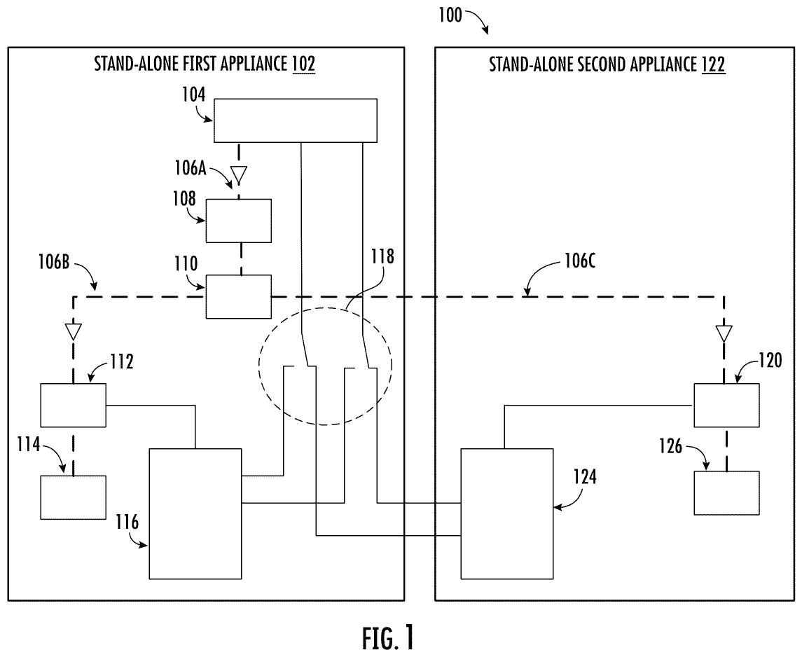

Referring now to FIG. 1, a first exemplary embodiment for water filtration system for two or more appliances in accordance with embodiments of the present disclosure. FIG. 1 includes a stand-alone first appliance 102, an inlet water valve 104, a plurality of water lines 106A-C, a water filter 108, a distribution valve 110, a water dispenser valve 112, a water dispenser 114, a first control circuit 116, a double pole double throw (DPDT) relay 118, a stand-alone second appliance 122, a second water dispenser valve 120, an ice maker 126, a second control circuit 124, and the like.

System 100 includes a stand-alone first appliance 102. As used in the current disclosure, the stand-alone first appliance refers to a self-contained cooling unit designed primarily for the storage and preservation of perishable food items and beverages. The stand-alone first appliance 102 may be referred to as simply a refrigerator throughout the remainder of this disclosure. The first appliance 102 may operate independently from other appliances, meaning it is not connected physically to a freezer unit. The first appliance 102 may include a thermally insulated compartment and a vapor-compression cooling system to maintain a controlled, low-temperature environment suitable for food preservation.

Embodiments of the stand-alone first appliance 102 that include a refrigerator may include several components that enable efficient cooling and storage. The refrigerator may include a compressor, condenser coils, evaporator coils, and a refrigerant system that work together to transfer heat from the interior compartment to the external environment. The compressor pressurizes the refrigerant, which circulates through the system, absorbing heat inside the refrigerator and releasing it outside. This process ensures that the interior remains at a temperature typically between 34 °F and 40 °F (1 °C to 4 °C).

With continued reference to FIG. 1, the first appliance 102 may include an inlet water valve 104. As used in the current disclosure, the inlet water valve is a valve used to control the flow of water from an external water supply into the appliance. The inlet water valve 104 is fluidically connected to an external water supply, meaning it is directly linked to a pipeline that transports water from an external source, such as a household plumbing system, to the refrigerator's internal water distribution components.

The inlet water valve 104 may include a solenoid-controlled mechanism, which regulates the opening and closing of the valve based on electronic signals from a control circuit, such as the first control circuit 116 or the second control circuit 124. When the inlet water valve 104 receives a control signal 306 requesting water the control circuit may energize the solenoid, causing the valve to open and allow pressurized water to flow through the inlet water valve 104 into the first water line 106A. Once the demand is met, the solenoid deactivates, closing the valve and stopping water flow.

System 100 includes a plurality of water lines 106A-C. As used in the current disclosure, the water lines 106A-C are tubing or piping designed to transport fluid throughout the water filtration system 100. System 100 includes a first water line 106A, which fluidically connects the inlet water valve 104 to the water filter 108, allowing water from an external source to be purified before further distribution. A second water line 106B extends from the distribution valve 110 to the water dispenser valve 112. A third water line 106C that carries filtered water from the distribution valve 110 to the second water dispenser valve. These water lines may be made from food-grade plastic or flexible copper tubing, ensuring safe water transport while resisting leaks and pressure fluctuations.

With continued reference to FIG. 1, the stand-alone first appliance 102 includes a water filter 108 that is fluidically connected to the distribution valve 110 via the first water line 106A. The water filter 108 may be designed to remove impurities, contaminants, and unwanted particles from the incoming water supply before it is distributed to the refrigerator's water dispenser and ice maker. The water filter 108 is fluidically connected to the inlet water valve 104 via the first water line 106A, meaning it receives water directly from the external water source through the inlet valve 104.

The water filter 108 may include a water inlet, which receives unfiltered water from the first water line 106A. As water enters the water filter 108, it passes through an internal filtration medium, which may be configured to remove sediments, chlorine, and other contaminants to improve water quality. Exemplary filtration mediums may include activated carbon, sediment filters, or multi-stage filtration materials. Once purified, the filtered water exits through a water outlet, which is fluidically connected to the distribution valve 110.

The water filter 108 may be located within the body of the first appliance 102 to allow for easy access and maintenance. In some embodiments, the water filter 108 may be positioned inside the fresh food compartment within the interior of the first appliance 102. The water filter 108 may be integrated into the refrigerator's interior without obstructing storage space. The water filter 108 may be housed in a dedicated compartment, allowing for quick and easy filter replacement when needed. In another embodiment, the water filter 108 may be installed near the rear wall of the refrigerator or within the base grille.

With continued reference to FIG. 1, the stand-alone first appliance 102 may include a distribution valve 110 fluidically connected to a second water line 106B and a third water line 106C. As used in the current disclosure, the distribution valve is a valve that is configured to direct the flow of filtered water. The distribution valve 110 may be configured to direct the flow of filtered water from the water filter 108 to different parts of the system, such as the first appliance 102 and the second appliance 122. The distribution valve 110 may be fluidically connected to the second water line 106B and the third water line 106C. This may enable the distribution valve 110 to selectively distribute water to multiple downstream components, such as a water dispenser valve 112 and a second water dispenser valve 120. The distribution valve 110 may utilize solenoid-controlled mechanisms or electronically actuated valves to control the water flow based on control signals 306 that are received from the control circuits.

In some cases, the distribution valve 110 may include a three-way valve. The distribution valve 110 may include one inlet port and two outlet ports, allowing it to control the flow of water between multiple destinations. The distribution valve 110 may be fluidically connected to the water filter 108. It may be further connected to both a second water line 106B and a third water line 106C, enabling the distribution valve 110 to selectively distribute water based on system demands. In operation, the distribution valve 110 may selectively facilitate the flow of filter water between the water dispenser valve 112 through the second water line 106B, or to the second water dispenser valve 120 through the third water line 106C based on the received control signal 306. A three-way distribution valve may utilize electromechanical actuation, solenoid control, or motor-driven mechanisms to manage water flow between its two outlet ports.

With continued reference to FIG. 1, the stand-alone first appliance 102 may include a water dispenser valve 112 fluidically connected to the second water line 106B. As used in the current disclosure, the water dispenser valve 112 is a valve responsible for controlling the flow of filtered water to the water dispenser 114 within the first appliance 102. The water dispenser valve 112 may be fluidically connected to the second water line 106B, which receives filtered water from the distribution valve 110. When activated, the dispenser valve 112 may selectively allow water to flow from the refrigerator's internal water system to the dispenser outlet, where it is accessible to the user.

In some embodiments, the water dispenser valve 112 may incorporate flow sensors or pressure regulators to maintain a consistent flow rate, preventing splashing or uneven dispensing. Additionally, the water dispenser valve 112 may include dual-stage valves, which provide variable flow control, allowing users to dispense water at different speeds.

The stand-alone first appliance 102 may include a water dispenser 114. As used in the current disclosure, the water dispenser 114 is a component designed to provide filtered water on demand. The water dispenser 114 is fluidically connected to the water dispenser valve 112. The water dispenser 114 serves as the delivery point for users to access drinking water conveniently, typically located on the exterior or interior of the refrigerator.

With continued reference to FIG. 1, stand-alone first appliance 102 includes a first control circuit 116. As used in the current disclosure, the first control circuit 116 is an electronic system designed to manage, regulate, and monitor the operations of the first appliance 102. This may be done by processing signals from various sensors, controls, and other components. The first control circuit 116 may include any processor, computing device, remote computing device, and the like mentioned herein. The first control circuit 116 may be configured to receive inputs, make decisions based on predefined parameters or algorithms, and then activate or deactivate specific functions or equipment within the stand-alone first appliance 102 or stand-alone second appliance 124. In an embodiment, the first control circuit 116 may be located within the stand-alone first appliance 102. Alternatively, the first control circuit 116 may include but is not limited to, for example, a computing device or cluster of computing devices that are remote from system 100, such as a remote server or cloud-based computing system. The first control circuit 116 may be consistent with any processor, computing device, and the like discussed within this disclosure.

With continued reference to FIG. 1, system 100 includes a stand-alone second appliance 122. As used in the current disclosure, a stand-alone second appliance 122 is an independent cooling unit designed solely for freezing and long-term food storage. Unlike combination refrigerator-freezer units, a stand-alone second appliance 122 functions as a dedicated freezing system, maintaining temperatures below freezing to preserve perishable food items, ice, and other frozen goods. The stand-alone second appliance 122 may be used in residential settings, commercial kitchens, food storage facilities, and the like where additional freezing capacity is required. In some embodiments, the second appliance 122 may include a stand-alone ice maker, a dishwasher, or any other kitchen appliance that consumes water.

As used in the present disclosure, the term “stand-alone” refers to an appliance that functions independently. Unlike side-by-side or stacked refrigerator-freezer combinations, a stand-alone first appliance 102 or stand-alone second appliance 122 may operate as a separate unit, without sharing cooling systems, control circuits, or physical space with the other. This separation may provide greater flexibility in placement, allowing users to position the first appliance 102 and second appliance 122 in various locations based on their needs. In some embodiments, the stand-alone first appliance 102 and stand-alone second appliance 122 may be placed adjacent to one another to mimic the appearance of a traditional side-by-side unit. Alternatively, they may be positioned at a greater distance from each other, such as in different rooms or areas of a residential or commercial setting.

Despite operating independently, a stand-alone first appliance 102 and stand-alone second appliance 122 can still function as part of an integrated appliance system, such as system 100 or system 200. In such cases, the second control circuit 124 may communicate with the first control circuit 116 to coordinate operations, such as managing water flow for ice production.

With continued reference to FIG. 1, the stand-alone second appliance 122 includes a second water dispenser valve 120. As used in the current disclosure, the second water dispenser valve is a valve designed to regulate the flow of water to a component of the second appliance 122. This valve may be used to provide the correct amount of water for an ice maker's mold for ice production. The second water dispenser valve 120 may operate by opening and closing in response to control signals 306, allowing water to enter the ice maker when needed and stopping the flow once the required amount has been dispensed.

The second water dispenser valve 120 may include an electrically controlled solenoid valve, which means it utilizes an electromagnetic coil to actuate its internal mechanism. When the valve receives a control signal 306, the solenoid coil generates a magnetic field, lifting an internal plunger or diaphragm to permit water flow. Once the signal ceases, the valve returns to its closed position, preventing any excess water from entering the system.

With continued reference to FIG. 1, the stand-alone second appliance 122 includes a second control circuit 124. As used in the current disclosure, the second control circuit is an electronic system designed to manage and regulate the operations of a stand-alone second appliance. Similar to the first control circuit 116, the second control circuit 124 may process processes inputs, generate/receive control signals 306, and coordinate the functions of various components within the freezer system. This includes managing temperature regulation, monitoring sensors, and controlling the flow of water for ice production. The second control circuit 124 may be implemented using a processor, microcontroller, or other computing devices capable of executing predefined control algorithms.

While the second control circuit 124 may function independently, it can also communicate with the first control circuit 116 when the freezer is part of an integrated system. This communication may allow the two appliances to share operational data and synchronize specific tasks, such as water distribution. In embodiments where the second control circuit 124 and first control circuit 116 are substantially similar, they may both be programmed with overlapping functionalities, including the ability to send and receive control signals 306 related to water flow and ice production.

The second control circuit 124 may be configured to selectively operate the second water dispenser valve 120 based on received control signals 306. When an ice-making cycle is initiated, the second control circuit 124 may generate the water parameter 304. The water parameter 304 may be transmitted by the second control circuit 124 to the first control circuit 116.

If the ice maker requires water, the second control circuit 124 may receive a control signal 306 from the first control circuit 116 indicating that the second water dispenser valve 120 should be opened. Upon receiving the appropriate control signal 306, the second control circuit 124 may activate the second water dispenser valve, allowing filtered water to flow into the ice mold through the third water line 106C. The valve remains open for a predetermined duration, ensuring that the correct amount of water is dispensed. Once the water has been delivered, the second control circuit deactivates the second water dispenser valve, stopping the flow of water and preventing overflow.

With continued reference to FIG. 1, the first control circuit 116 may be configured to selectively operate the plurality of valves using a double pole double throw (DPDT) relay 118. As used in the current disclosure, a double pole double throw (DPDT) relay 118 is an electromechanical switching device used to control multiple circuits simultaneously. It may consist of two separate input terminals (poles) and two sets of output terminals (throws), allowing it to switch between two different circuit paths for each pole. The DPDT relay 118 may operate using an electromagnet that, when energized, moves internal contacts to change the state of the connected circuits. DPDT relay 118 may be used to switch operational states of the plurality of valves. Specifically, the DPDT relay 118 may be used to control the flow of water by selectively activating or deactivating various valves within the first appliance 102 and second appliance 122.

The DPDT relay 118 may be used to manage the operational states of the plurality of valves, such as the inlet water valve 104, distribution valve 110, water dispenser valve 112, second water dispenser valve 120, and any other valve mentioned herein. The DPDT relay 118 may have two independent circuits that can switch between two positions, allows the first control circuit 116 or the second control circuit 124 to control the valves by determining the appropriate water distribution path.

For instance, when the first control circuit 116 dictates the need for water from the water dispenser 114, the DPDT relay 118 may be energized, shifting the internal contacts to complete the electrical connection that activates the water dispenser valve 112 while simultaneously disengaging the second water dispenser valve 120 to prevent unnecessary water flow to the ice maker. Once the need for water has been fulfilled, the DPDT relay 118 may deactivate, closing the water dispenser valve 112 and returning the system to its default state.

Similarly, when the second control circuit 124 has a demand for ice production, the DPDT relay 118 can be used to direct water to the ice maker 126. In this case, the first control circuit 116 may energize the relay in a different configuration, allowing it to open the second water dispenser valve 120 while ensuring the water dispenser valve 112 remains closed.

In some embodiments, the DPDT relay 118 may be integrated with additional control components such as timers, sensors, or microcontrollers to further optimize water distribution. For example, if the system detects that the ice bin is full, the DPDT relay 118 can automatically switch states to disable the second water dispenser valve, preventing overproduction of ice and potential overflow.

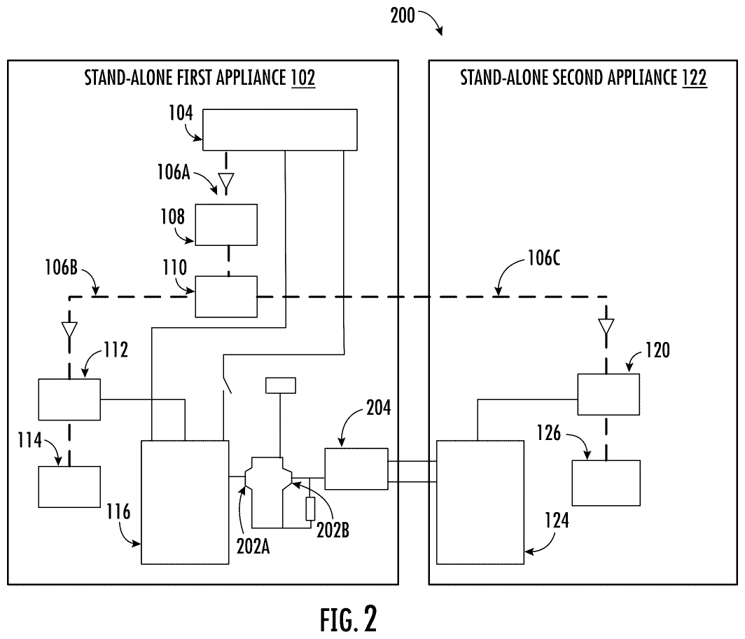

Referring now to FIG. 2, a diagram of a water filtration system for two or more appliances in accordance with embodiments of the present disclosure. The embodiment illustrated in FIG. 2 may be the same or substantially similar to that of FIG. 1, except for differences in the control logic. In FIG. 1, a double pole double throw (DPDT) relay 118 is used to control the operation of various valves within the system, whereas in FIG. 2, the DPDT relay 118 is replaced with a plurality of transistors 202A-B. This modification changes how the control signals 306 are processed and executed. Despite this difference in control logic, the overall function and structure of system 200 may remain the same or substantially similar to that of system 100.

As used in the current disclosure, a transistor is a semiconductor device used to switch electronic signals and electrical power. The plurality of transistors 202A-B can function as an electronic switch that changes the state of the plurality of valves between open and closed positions. The plurality of transistors 202A-B may be controlled by an electrical signal, which determines whether it allows current to flow through the valve actuator. When the plurality of transistors 202A-B are activated, they may permit electrical currents to energize two or more valves of the plurality of valves, causing them to open and allow water to flow. Conversely, when the transistor is deactivated, the electrical current is interrupted, and the valve closes, stopping the water flow.

System 200 may include two or more transistors that are configured to actuate the plurality of valves associated with either the first appliance 102 or the second appliance 122. The plurality of transistors 202A-B may include a first transistor 202A associated with the stand-alone first appliance 102, controlling water flow to the water dispenser valve 112. The plurality of transistors 202A-B may include a second transistor 202B associated with the stand-alone second appliance 122, managing water flow to the second water dispenser valve 120. Each transistor within the plurality of transistors 202A-B may act as a control mechanism that responds to control signals 306 from the first control circuit 116 and the second control circuit 124, respectively.

To provide water to the water dispenser valve 112, the first control circuit 116 may generate a control signal 306 that activates the first transistor 202A. When the user input 302 is detected at the water dispenser 114, the first control circuit 116 may process this request and send an electrical signal to the first transistor 202A based on the control signal 306. This may cause the first transistor 202A to switch on, allowing current to flow to the water dispenser valve 112. As a result, the water dispenser valve 112 opens, enabling filtered water to flow thorough the distribution valve through the water dispenser 114. When the user input 302 is released, the first control circuit 116 may deactivate the first transistor 202A, cutting off the current and closing the valve to stop the water flow.

Similarly, the second transistor 202B may be used to provide water to the second water dispenser valve 120. When the first control circuit 116 determines that the ice maker 126 requires water, it may generate a control signal 306 that is transmitted to the second control circuit 124. The second control circuit 124 may then relay the control signal 306 to the second transistor 202B. This control signal 306 activates the second transistor 202B allowing current to flow to the second water dispenser valve 120. The second water dispenser valve 120 then opens permitting filtered water to enter the ice mold for ice production. Once the necessary amount of water has been delivered, the second control circuit 124 deactivates the second transistor 202B, which in turn shuts off the second water dispenser valve, preventing excess water from entering the ice maker.

With continued reference to FIG. 2, the stand-alone first appliance may be communicatively connected to the stand-alone second appliance using an optical isolator 204. As used in the current disclosure, an optical isolator is an electronic component that enables signal transmission between two circuits while maintaining electrical isolation. The two circuits may include but are limited to the first control circuit 116 and the second control circuit 124.

The optical isolator 204 may include a light-emitting diode (LED) and a photodetector, such as a phototransistor. When an electrical signal, such as the control signal 306, water parameter 304, user input 302, and the like, is applied to the input side, the LED emits light and is detected by the phototransistor on the output side. This optical coupling allows electrical signals to pass between control circuits without a direct electrical connection, thereby preventing high voltages or noise from transferring between components.

The optical isolator 204 can be used to electrically isolate the second control circuit 124 from the first control circuit 116. This isolation may be useful when the two appliances operate with different power supplies or ground references. By using an optical isolator 204, control signals 306 can be transmitted between the refrigerator and freezer without introducing electrical interference or ground loop issues. For example, when the first control circuit 116 sends a control signal 306 to activate the second water dispenser valve 120, the optical isolator 204 may transmit that signal to the second control circuit 124 without creating unintended electrical connections between the two systems.

This electrical isolation is especially useful in an embodiment where a plurality of transistors 202A-B are used to control various valves within the system. Since transistors are semiconductor devices that can be sensitive to fluctuations in voltage and current, the optical isolator 204 may be used to prevent unintended interference or damage caused by differing electrical potentials between the refrigerator and freezer circuits.

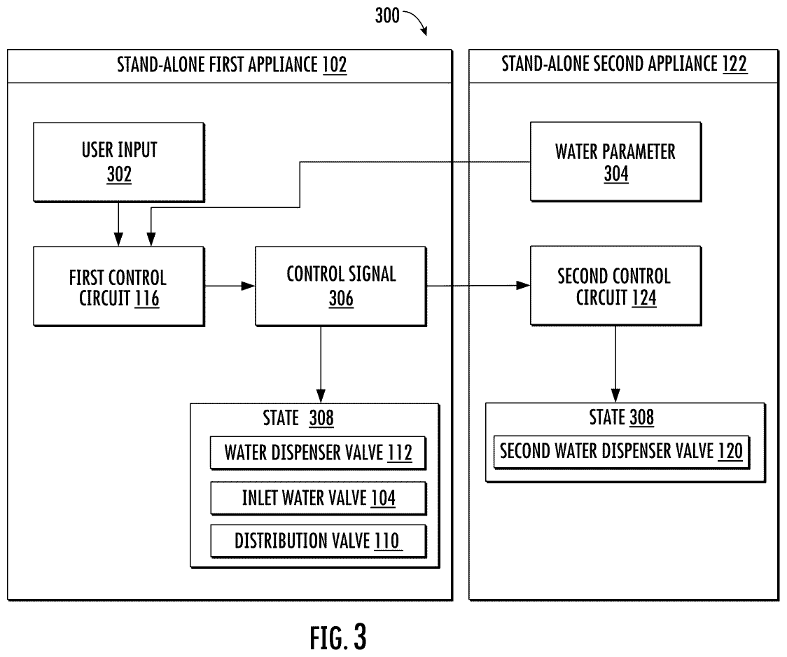

Referring now to FIG. 3, an exemplary block diagram for a water filtration system for two or more appliances in accordance with embodiments of the present disclosure.

The first control circuit 116 and the second control circuit 124 may include one or more processors that can be utilized to perform one or more operations. The one or more processors can include any suitable processing device (e.g., a processor core, a microprocessor, an ASIC, a FPGA, a controller, a microcontroller, etc.) and can be one processor or a plurality of processors that are operatively connected. The one or more processors can perform operations in series and/or in parallel. The one or more processors may be dedicated to a particular computing device and/or may be utilized by a plurality of devices to perform processing tasks.

The one or more processors may be designed and/or configured to perform any method, method step, or sequence of method steps in any embodiment described in this disclosure, in any order and with any degree of repetition. For instance, processor may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks.

The processor may include a single computing device operating independently or may include two or more computing devices operating in concert, in parallel, sequentially, or the like; two or more computing devices may be included together in a single computing device or in two or more computing devices. Processor may include but is not limited to, for example, a computing device or cluster of computing devices in a first location and a second computing device or cluster of computing devices in a second location. The processor may include one or more computing devices dedicated to data storage, security, distribution of traffic for load balancing, and the like. Processors may distribute one or more operations as described below across a plurality of computing devices, which may operate in parallel, in series, redundantly, or in any other manner used for the distribution of tasks or memory between computing devices.

The first control circuit 116 and the second control circuit 124 may include a memory that can store data and/or instructions. The memory can include one or more non-transitory computer-readable storage mediums, such as RAM, ROM, EEPROM, EPROM, flash memory devices, magnetic disks, etc., and combinations thereof. The data can include user data, application data, operating system data, etc. The data can include control signals, water parameters, user inputs, text data, image data, audio data, statistical data, etc. The instructions can include instructions that when executed by one or more of the processors may cause system 100 and/or system 200 to perform operations as described herein.

In some cases, the first control circuit 116 may be configured to receive a user input 302 associated with the water dispenser. In an embodiment, the water dispenser 114 may include a mechanism for generating the user input 302. This mechanism may allow users to request water flow from the first appliance 102. This mechanism may take various forms, including a lever, button, touch-sensitive control, or sensor-based activation system. For instance, a mechanical lever may be positioned beneath the dispenser spout of the water dispenser 114, enabling users to press a cup or container against it to activate the water dispenser valve 112, allowing water to flow. In another instance, a push-button mechanism may be used, where the user manually presses a button to open the water dispenser valve 112 and release it to stop the flow of water. In a third instance, the system may feature touch or motion sensors, allowing for hands-free operation by detecting user presence and dispensing water accordingly.

The user input 302 may be transmitted to the first control circuit 116 through a direct connection or communication interface, allowing the system 100 or system 200 to respond to user requests. When the user activates the mechanism for user input 302, the action triggers an electronic signal that is sent to the first control circuit 116. This signal can be transmitted through a wired or wireless interface.

The first control circuit 116 may also be configured to receive a water parameter 304 from the second control circuit 124. As used in the current disclosure, the water parameter 304 refers to a set of conditions or data used to determine an appliance's need for filtered water in the ice-making process. This water parameter 304 may be used to manage the flow of filtered water to the second water dispenser valve 120. The water parameter 304 may be used to assess various factors, including the current ice-making cycle, the ice maker's demand for water, and whether additional water is needed for ice production.

The water parameter 304 may indicate whether the ice maker 126 requires water to produce more ice. If the ice maker's storage bin is low or empty, the water parameter 304 may signal the first control circuit 116 to open the second water dispenser valve 120 and allow filtered water to flow. Additionally, the water parameter 304 may track the ice production cycle, noting whether the cycle is ongoing or has recently been completed. If a new cycle is starting, the water parameter 304 may prompt the first control circuit 116 to supply water to the ice maker.

The first control circuit 116 may be configured to perform operations that include determining a control signal 306 to control a state 308 of a plurality of valves, such as the inlet valve 104, distribution valve 110, water dispenser valve 112, second water dispenser valve 120, and the like. This may be done in response to the user input 302 and water parameter 304. As used in the current disclosure, the control signal 306 may be a signal that manages and/or regulates operation of a system or device, such as the plurality of valves. The control signal 306 may specify a desired action of system 100 or system 200, this may include actions such as changing the state 308 of two or more valves of the plurality of valves (e.g., between on and off). The control signal 306 may include actions such as switching a group of valves operational states 308 using the DPDT relay 118. Additionally or alternatively, the control signal 306 may include actions such as engaging or disengaging one or more transistors of the plurality of transistors 202A-B.

The actions that are instructed by the control signal 306 may be done to facilitate the flow of filtered water to the water dispenser 114 and/or the ice maker 126. Based on the user input 302 and/or the water parameter 304, the first control circuit 116 may determine which valves of the plurality of valves should be opened or closed. For example, when the first control circuit 116 receives a user input 302 requesting water, the first control circuit 116 might generate a control signal 306 that opens the inlet valve 104, the distribution valve 110, and the water dispenser valve 112, while simultaneously closing the second water dispenser valve 120. Conversely, if the water parameter 304 indicates that the ice maker needs water, the control signal 306 may include a signal that opens the inlet valve 104, the distribution valve 110, and the second water dispenser valve 120, while closing the water dispenser valve 112.

The first control circuit 116 is configured to transmit the control signal 306 to the second control circuit 124. Upon receiving the control signal 306, the second control circuit 124 can modify the state 308 of the second water dispenser valve 120, facilitating or restricting water flow for ice production.

The first control circuit 116 may selectively operate the water dispenser valve 112 and the inlet water valve 104 based on the control signal 306. For example, when a user input 302 is detected at the water dispenser 114, the first control circuit 116 may process the request and generate a corresponding control signal 306. This control signal 306 may open the inlet water valve 104 and the water dispenser valve 112, allowing water to flow into the dispenser. Once the user releases the dispenser mechanism, the first control circuit 116 may close both valves, halting water flow.

The first control circuit 116 may also utilize the control signal 306 to regulate ice production in response to the water parameter 304. If the water parameter 304 indicates a need for more ice, the first control circuit 116 can generate a control signal 306, instructing the second control circuit 124 to open the second water dispenser valve 120. This may be done while the first control circuit 116 opens the inlet water valve 104 and the water dispenser valve 112 to allow filtered water to enter the ice-making system. Once the ice bin reaches capacity, the control signal 306 may be used to prompt the second control circuit 124 to close the second water dispenser valve 120 to stop the flow of filtered water to the ice maker.

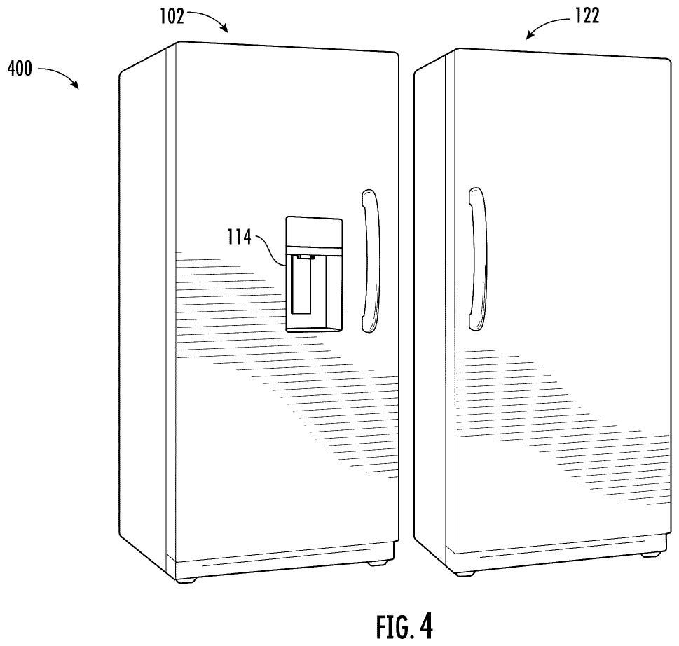

Referring now to FIG. 4, an isometric view of a stand-alone first appliance 102 and a stand-alone second appliance 122 in accordance with embodiments of the present disclosure.

The stand-alone first appliance 102 and the stand-alone second appliance 122 are each designed with a cabinet or housing that encloses their respective storage compartments. The first appliance 102 includes a refrigeration chamber that is configured to maintain food and beverages at a controlled cool temperature, while the second appliance 122 features a freezer chamber that is designed to store frozen goods. Unlike combined refrigerator-freezer units, these appliances are independent of one another, allowing for separate placement within a home, restaurant, or commercial environment. This stand-alone configuration enables users to position the refrigerator and freezer according to their space and usage preferences, whether adjacent to each other or in entirely different locations.

Each appliance may feature a single-door configuration, where the doors are rotatably hinged to an edge of the housing, providing direct access to the refrigeration or freezer chamber. The doors may be designed to form an airtight seal to maintain the internal temperature of the refrigerator or freezer chamber.

Alternatively, the appliances may feature a one, two, or three-door configuration. This may include a side-by-side configuration, where two doors open adjacent to each other, a stacked configuration with separate compartments arranged vertically, or a combination of the two. In some cases, the appliances may incorporate a refrigerated or freezer drawer instead of one of the doors.

The first appliance 102 may be equipped with a water dispenser 114, designed to provide water. This water dispenser 114 may be positioned on the exterior portion of the appliance. The water dispenser 114 may include a discharging outlet fluidically connected to the water dispenser valve 112. In some embodiments, the first appliance 102 may also feature a user interface panel, enabling users to control the operational modes of both the dispenser 114 and other refrigerator functions. The user interface panel may be used to facilitate receiving the user input 302.

The discharging outlet may be an external component of the water dispenser 114 that is mounted within a dispensing recess or recessed portion on the outer surface of the refrigerator door. This recessed portion may be positioned at a predetermined elevation to ensure user accessibility. In an exemplary embodiment, the recessed portion may be aligned approximately with a user's chest level. However, alternative embodiments may position the water dispenser 114 within the refrigeration chamber.

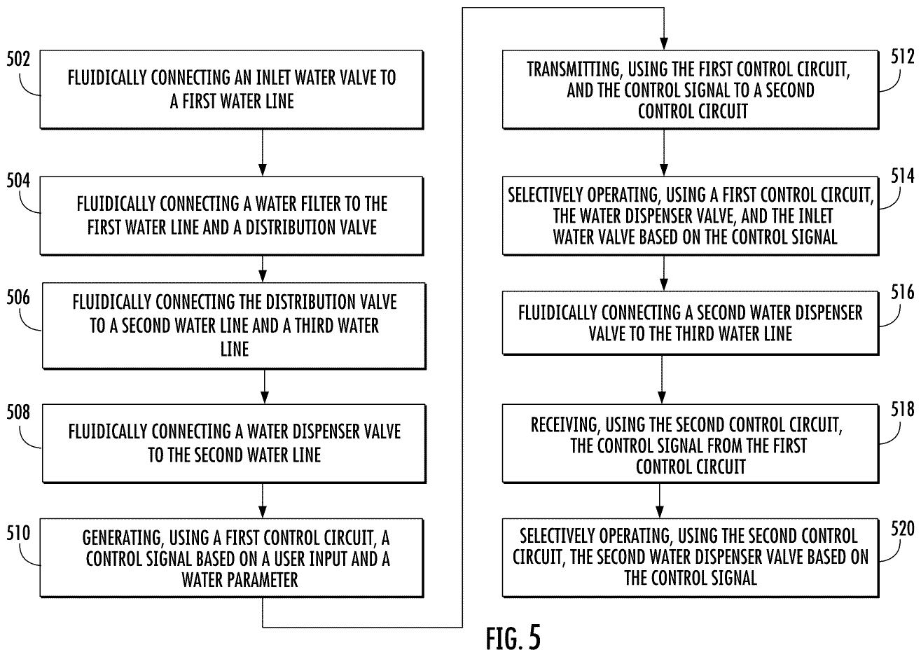

The refrigeration chamber of the stand-alone first appliance 102 and the freezer chamber of the stand-alone second appliance 122 may each include a plurality of shelves and drawers positioned at different levels within the housing. These storage elements allow for the placement of various food items and beverages. In a non-limiting example, the shelves may be door-mounted or rack-mounted, retained within the interior portion of the appliance housing. Additionally, sliding drawers may be positioned below or between shelves, offering compartments for storing produce, frozen goods, or other foodstuffs. Referring now to FIG. 5, a flow diagram of an exemplary method of water filtration for two or more appliances in accordance with embodiments of the present disclosure.

Referring now to FIG. 5, a flow diagram of an exemplary method of water filtration for two or more appliances in accordance with embodiments of the present disclosure.

At operation 502, the method includes fluidically connecting an inlet water valve to a first water line.

At operation 504, the method includes fluidically connecting a water filter to the first water line and a distribution valve.

At operation 506, the method includes fluidically connecting the distribution valve to a second water line and a third water line.

At operation 508, the method includes fluidically connecting a water dispenser valve to the second water line.

At operation 510, the method includes generating, using a first control circuit, a control signal based on a user input and a water parameter.

At operation 512, the method includes transmitting, using the first control circuit, and the control signal to a second control circuit.

At operation 514, the method includes selectively operating, using a first control circuit, the water dispenser valve, and the inlet water valve based on the control signal.

In an embodiment, selectively operating the plurality of valves may include changing the state of two or more valves in response to the control signal. This may include the water dispenser valve, the second water dispenser valve, and the inlet water valve. By modifying the state of these valves, the system may direct the flow of filtered water to the appropriate appliance or component.

The distribution valve may be configured to direct the filtered water to the water dispenser valve or the second water dispenser valve based on the control signal received from the first control circuit. For example, when a user requests water from the dispenser, the control circuit processes the input and sends a signal to open the necessary valves. Alternatively, when the second control circuit determines that ice production is needed, it communicates with the first control circuit to engage the appropriate valves. The distribution valve may then route the filtered water exclusively to the second water dispenser valve.

At operation 516, the method includes fluidically connecting a second water dispenser valve to the third water line. and

At operation 518, the method includes receiving, using the second control circuit, the control signal from the first control circuit.

At operation 520, the method may include selectively operating, using the second control circuit, the second water dispenser valve based on the control signal.

In an embodiment, the first control circuit may include a plurality of transistors that facilitate selective valve operation. The plurality of transistors may include a first transistor that is communicatively connected to both the water dispenser valve and the inlet water valve. Additionally, a second transistor may be communicatively connected to both the second water dispenser valve and the inlet water valve.

In some cases, the control signal can engage the first transistor to operate the water dispenser valve and the inlet water valve. When a user activates the water dispenser, the control circuit sends a signal to switch the first transistor into an active state. This allows water to flow through the inlet water valve and into the water dispenser valve, facilitating dispensing.

In other cases, the control signal can also engage the second transistor to operate the second water dispenser valve and the inlet water valve. When the freezer requires water for ice production, the first control circuit may activate the second transistor. This engagement allows filtered water to flow through the inlet water valve and into the second water dispenser valve.

In an additional embodiment, the method may include the use of a double pole double throw (DPDT) relay to selectively operate the plurality of valves. In response to the control signal, the DPDT relay can switch between states, directing water flow to the appropriate component.

When the control signal activates the DPDT relay, it may switch states to engage the water dispenser valve and the inlet water valve. In this configuration, filtered water flows to the water dispenser while the second water dispenser valve remains disengaged.

Alternatively, the control signal can cause the DPDT relay to switch states and engage the second water dispenser valve and the inlet water valve. This configuration ensures that filtered water flows exclusively to the ice maker, while the water dispenser valve remains disengaged.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A water filtration system for two or more appliances comprising:
a stand-alone first appliance comprising:
an inlet water valve fluidically connected to a first water line;
a water filter fluidically connected to the first water line and a distribution valve;
the distribution valve fluidically connected to a second water line and a third water line;
a water dispenser valve fluidically connected to the second water line; and
a first control circuit configured to:
generate a control signal based on a user input and a water parameter; and
transmit the control signal to a second control circuit; and
selectively operate the water dispenser valve and the inlet water valve based on the control signal; and
a stand-alone second appliance comprising:
a second water dispenser valve fluidically connected to the third water line; and
the second control circuit configured to:
receive the control signal from the first control circuit; and
selectively operate the second water dispenser valve based on the control signal.

2. The water filtration system of claim 1, wherein the control signal comprises changing a state of two or more of the following: the water dispenser valve, the second water dispenser valve, and the water dispenser valve.

3. The water filtration system of claim 1, wherein the distribution valve is configured to direct filtered water to the water dispenser valve in response to the control signal.

4. The water filtration system of claim 1, wherein the distribution valve is configured to direct filtered water to the second water dispenser valve in response to the control signal.

5. The water filtration system of claim 1, wherein the first control circuit a plurality of transistors, wherein the plurality of transistors comprises:
a first transistor electrically connected to the water dispenser valve and the inlet water valve; and
a second transistor electrically connected to the second water dispenser valve and the inlet water valve.

6. The water filtration system of claim 5, wherein the control signal comprises engaging the first transistor.

7. The water filtration system of claim 5, wherein the control signal comprises engaging the second transistor.

8. The water filtration system of claim 1, wherein selectively operating the water dispenser valve and the inlet water valve comprises selectively operating, using a double pole double throw (DPDT) relay, the water dispenser valve and the inlet water valve based on the control signal.

9. The water filtration system of claim 8, wherein the control signal causes the DPDT relay to switch states, engaging the water dispenser valve and the inlet water valve while disengaging the second water dispenser valve.

10. The water filtration system of claim 8, wherein the control signal causes the DPDT relay to switch states, engaging the second water dispenser valve and the inlet water valve while disengaging the water dispenser valve.

11. The water filtration system of claim 1, wherein the stand-alone first appliance and the stand-alone second appliance are located adjacent to one another.

12. A water filtration system for two or more appliances comprising:
a stand-alone first appliance comprising:
an inlet water valve fluidically connected to a first water line;
a water filter fluidically connected to the first water line and a distribution valve;
the distribution valve fluidically connected to a second water line and a third water line;
a water dispenser valve fluidically connected to the second water line; and
a first control circuit configured to:
generate a control signal based on a user input and a water parameter;
transmit the control signal to a second control circuit; and
selectively operate, using a double pole double throw (DPDT) relay, the water dispenser valve and the inlet water valve based on the control signal; and
a stand-alone second appliance comprising:
a second water dispenser valve fluidically connected to the third water line; and
a second control circuit configured to:
receive the control signal from the first control circuit; and
selectively operate, using the DPDT relay, the second water dispenser valve based on the control signal.

13. The water filtration system of claim 12, wherein the control signal causes the DPDT relay to switch states, engaging the water dispenser valve and the inlet water valve while disengaging the second water dispenser valve.

14. The water filtration system of claim 12, wherein the control signal causes the DPDT relay to switch states, engaging the second water dispenser valve and the inlet water valve while disengaging the water dispenser valve.

15. A water filtration system for two or more appliances comprising:
a stand-alone first appliance comprising:
an inlet water valve fluidically connected to a first water line;
a water filter fluidically connected to the first water line and a distribution valve;
the distribution valve fluidically connected to a second water line and a third water line;
a water dispenser valve fluidically connected to the second water line;
a first control circuit configured to:
generate a control signal based on a user input and a water parameter;
transmit the control signal to a second control circuit; and
selectively operate, using a plurality of transistors, the water dispenser valve and the inlet water valve based on the control signal; and
a stand-alone second appliance comprising:
a second water dispenser valve fluidically connected to the third water line; and
the second control circuit configured to:
receive the control signal from the first control circuit; and
selectively operate, using the plurality of transistors, the second water dispenser valve based on the control signal.

16. The water filtration system of claim 15, wherein the first control circuit is further configured to transmit the control signal to the second control circuit using an optical isolator.

17. The water filtration system of claim 16, wherein the stand-alone first appliance is electrically isolated from the stand-alone second appliance.

18. The water filtration system of claim 15, wherein the plurality of transistors comprises:
a first transistor electrically connected to the water dispenser valve and the inlet water valve; and
a second transistor electrically connected to the second water dispenser valve and the inlet water valve.

19. The water filtration system of claim 18, wherein the control signal comprises engaging the first transistor.

20. The water filtration system of claim 18, wherein the control signal comprises engaging the second transistor.
